(19) United States
(12) Patent Application Publication
(10) Pub. No.: US 2025/0307126 A1
(43) Pub. Date: Oct. 2, 2025

(54) PRACTICAL COVERAGE CHECKING MECHANISM BASED ON ACTUAL TEST EXECUTION LOGS

(71) Applicant: Dell Products L.P., Round Rock, TX (US)

(72) Inventors: Changxu Jiang, Chengdu (CN); Robin Fei Wang, Chengdu (CN); Huijuan Fan, Chengdu (CN)

(73) Assignee: Dell Products L.P., Round Rock, TX (US)

(21) Appl. No.: 18/756,257

(22) Filed: Jun. 27, 2024

(30) Foreign Application Priority Data
Mar. 26, 2024 (CN) 202410353392.3

(51) Int. Cl. G06F 11/36

(52) U.S. Cl. CPC G06F 11/3692

(57) ABSTRACT

Methods, system, and non-transitory processor-readable storage medium for a command coverage assessment system are provided herein. An example method includes executing at least one test case on a system. A command coverage assessment system obtains at least one test case log resulting from the execution of the one or more test case. The command coverage assessment system generates a command coverage report using a command tree map, based on the at least one test case log.

### FIELD

The field relates generally to providing test coverage according to customer usage of software products, and more particularly to providing test coverage in information processing systems.

### BACKGROUND

Typically, testing efforts for complex software systems are divided into functional testing and system integration testing. Ideally, functional testing captures functional regression issues as soon as possible, but, often, these issues are caught during the system integration testing phase, potentially causing a delay in the release of the software.

### SUMMARY

Illustrative embodiments provide techniques for implementing a command coverage assessment system in a storage system. For example, illustrative embodiments execute at least one test case on a system. A command coverage assessment system obtains at least one test case log resulting from the execution of at least one test case, and generates a command coverage report using a command tree map, based on at least one test case log. Other types of processing devices can be used in other embodiments. These and other illustrative embodiments include, without limitation, apparatus, systems, methods and processor-readable storage media.

### BRIEF DESCRIPTION OF THE DRAWINGS

FIG. 1 shows an information processing system including a command coverage assessment system in an illustrative embodiment.

FIG. 2 shows a command coverage assessment system in an illustrative embodiment.

FIG. 3 shows a flow diagram of a process for a command coverage assessment system in an illustrative embodiment.

FIG. 4 illustrates a primary child store layout for the command svc_storage_integrity_check in an illustrative embodiment.

FIG. 5 illustrates a child node data layout of the command tree map in an illustrative embodiment.

FIG. 6 illustrates updating the weights of a base tree primary child store in an illustrative embodiment.

FIG. 7 illustrates the storing of commands in groups of command tree maps in an illustrative embodiment.

FIG. 8 illustrates a flowchart to collect coverage statistics in an illustrative embodiment.

FIG. 9 illustrates the updated command tree map (i.e., primary child store) of a command in an illustrative embodiment.

FIG. 10 illustrates information that is collected to update command tree maps in an illustrative embodiment.

FIG. 11 illustrates a command tree map for the “svc_storage_integrity_check” command in an illustrative embodiment.

FIG. 12 illustrates an example interface in an illustrative embodiment.

FIG. 13 illustrates the test case logs that the command coverage assessment system analyzes in the test logs path in an illustrative embodiment.

FIG. 14 illustrates an updated command tree map reflecting actual coverage statistics in an illustrative embodiment.

FIGS. 15, 16, and 17 illustrate an example commands coverage report in an illustrative embodiment.

FIGS. 18 and 19 show examples of processing platforms that may be utilized to implement at least a portion of a command coverage assessment system embodiments.

### DETAILED DESCRIPTION

Illustrative embodiments will be described herein with reference to exemplary computer networks and associated computers, servers, network devices or other types of processing devices. It is to be appreciated, however, that these and other embodiments are not restricted to use with the particular illustrative network and device configurations shown. Accordingly, the term “computer network” as used herein is intended to be broadly construed, so as to encompass, for example, any system comprising multiple networked processing devices.

Described below is a technique for use in implementing a command coverage assessment system, which technique may be used to determine, among other things, whether user issued commands are actually tested by regression test cases by executing at least one test case on a system. A command coverage assessment system obtains at least one test case log resulting from the execution of at least one test case, and generates a command coverage report using a command tree map, based on at least one test case log.

Typically a software product is tested by executing code coverage testing. Conventional technologies for performing code coverage testing are not able to prioritize those code paths that are touched by users. Conventional technologies develop regression tests to meet code coverage requirements using assumed inputs instead of using actual customer inputs and usage details. Conventional technologies that focus on code coverage lose sight of which commands customers are actually using. Conventional technologies create regression tests based on how the regression test developers envision the software products is used by the customer, but not how the software product is actually used by the customer. Conventional technologies fail to provide coverage analysis for the commands used by customers by analyzing test logs. Conventional technologies fail to identify and resolve the gap between the functional specifications and the actual code usage by the customers. Conventional technologies fail to provide a tool that can utilize both the functional specifications and the regression test logs to increase the code testing coverage.

By contrast, in at least some implementations in accordance with the current technique as described herein, functional code coverage is verified by executing at least one test case on a system. A command coverage assessment system obtains at least one test case log resulting from the execution of at least one test case, and generates a command coverage report using a command tree map, based on at least one test case log.

Thus, a goal of the current technique is to provide a method and a system for a command coverage assessment system that utilizes both the functional specifications and the regression test logs to increase the code testing coverage. Another goal is to perform code coverage testing prioritizing the code paths that are touched by users. Another goal is to develop regression tests to meet code coverage requirements using actual customer inputs and usage details. Another goal is to provide coverage analysis for the commands used by customers by analyzing test logs. Yet another goal is to identify and resolve the gap between the functional specifications and the actual code usage by the customers.

In at least some implementations in accordance with the current technique described herein, the use of a command coverage assessment system can provide one or more of the following advantages: providing information for code coverage testing that prioritizes code paths that are touched by users, providing information to develop regression tests to meet code coverage requirements using customer inputs and usage details, providing coverage analysis for the commands used by customers by analyzing test logs, identifying and resolving the gap between the functional specifications and the actual code usage by the customers, and providing a tool that can utilize both the functional specifications and the regression test logs to increase the code testing coverage.

In contrast to conventional technologies, in at least some implementations in accordance with the current technique as described herein, regression testing is verified by executing at least one test case on a system. A command coverage assessment system obtains at least one test case log resulting from the execution of at least one test case, and generates a command coverage report using a command tree map, based on at least one test case log.

In an example embodiment of the current technique, a covered commands pool module parses at least one test case log to obtain commands transmitted to the system during the execution of at least one test case, where the command coverage assessment system comprises the covered commands pool module.

In an example embodiment of the current technique, the covered commands pool module obtains a plurality of covered commands and a covered command count associated with each of the respective plurality of covered commands, where the covered command count indicates a total occurrence of each of the respective plurality of covered commands in at least one test log.

In an example embodiment of the current technique, the covered commands pool module updates the command tree map associated with a covered command with the respective covered command count, where the plurality of covered commands comprises the covered command.

In an example embodiment of the current technique, a commands coverage report module outputs an analysis report indicating whether target commands in a target commands namespace are covered in a covered commands pool associated with a covered commands pool module, where the covered commands pool comprises covered commands in at least one test log, and where the command coverage assessment system comprises the commands coverage report module and the covered commands pool module.

In an example embodiment of the current technique, the analysis report further comprises a coverage level associated with the covered commands and a coverage level requirement threshold.

In an example embodiment of the current technique, the command coverage assessment system evaluates at least one test case log to identify usage of at least one command used during the execution of at least one test case.

In an example embodiment of the current technique, the command coverage assessment system generates a data structure for command coverage analysis.

In an example embodiment of the current technique, the command coverage assessment system instantiates at least one command tree map comprising at least one primary node and at least one child node.

In an example embodiment of the current technique, an adjustable target commands namespace module generates a target commands namespace comprising at least one target command, where at least one test case comprises testing at least one target command, and where the command coverage assessment system comprises the adjustable target commands namespace module.

In an example embodiment of the current technique, the adjustable target commands namespace module obtains from a target commands namespace, target command coverage information, assigns a weight to the target command coverage information, and stores the weight in a child node of the command tree map.

In an example embodiment of the current technique, the child node comprises a hit ratio associated with a command executed during the execution of the test case.

In an example embodiment of the current technique, the hit ratio is a normalized covered command count, where the covered command count indicates a total occurrence of a covered command in at least one test log.

In an example embodiment of the current technique, the command coverage assessment system stores a sum of a plurality of weights in a primary node, where the plurality of weights is associated with a respective plurality of child nodes associated with the primary node, and where the plurality of child nodes comprises the child node.

In an example embodiment of the current technique, the command coverage assessment system creates the command tree map for each target command in the target commands namespace, where each respective command tree map comprises full usage combinations of the target command, and where each respective command tree map comprises a respective primary node and at least one respective child node.

In an example embodiment of the current technique, the command coverage assessment system updates the weight in the child node of the command tree map based on information associated with the full usage combination of the command.

In an example embodiment of the current technique, the command coverage assessment system queries the command tree map associated with a command to determine whether a covered commands pool associated with a covered commands pool module comprises the command, where a target commands namespace associated with an adjustable target commands namespace module comprises the command, and where the command coverage assessment system comprises the adjustable target commands namespace module and the covered commands pool module.

In an example embodiment of the current technique, the command coverage assessment system determines whether a coverage level associated with the command meets a requirement threshold.

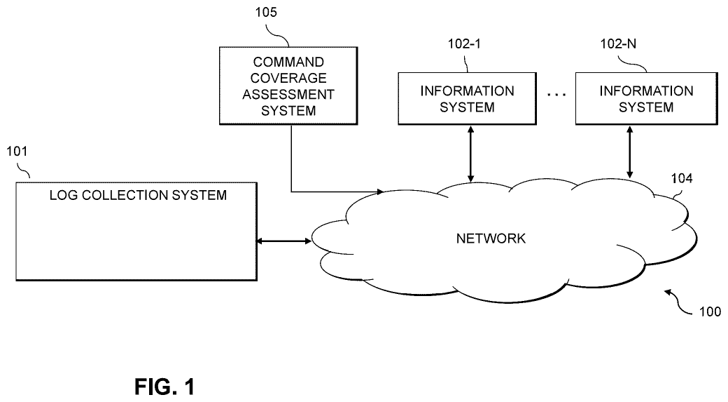

FIG. 1 shows a computer network (also referred to herein as an information processing system) 100 configured in accordance with an illustrative embodiment. The computer network 100 comprises a log collection system 101, command coverage assessment system 105, and information systems 102-N. The log collection system 101, command coverage assessment system 105, and information systems 102-N are coupled to a network 104, where the network 104 in this embodiment is assumed to represent a sub-network or other related portion of the larger computer network 100. Accordingly, elements 100 and 104 are both referred to herein as examples of “networks,” but the latter is assumed to be a component of the former in the context of the FIG. 1 embodiment. Also coupled to network 104 is a command coverage assessment system 105 that may reside on a storage system. Such storage systems can comprise any of a variety of different types of storage including network-attached storage (NAS), storage area networks (SANs), direct-attached storage (DAS) and distributed DAS, as well as combinations of these and other storage types, including software-defined storage.

Each of the information systems 102-N may comprise, for example, servers and/or portions of one or more server systems, as well as devices such as mobile telephones, laptop computers, tablet computers, desktop computers or other types of computing devices. Such devices are examples of what are more generally referred to herein as “processing devices.” Some of these processing devices are also generally referred to herein as “computers.”

The information systems 102-N in some embodiments comprise respective computers associated with a particular company, organization or other enterprise. In addition, at least portions of the computer network 100 may also be referred to herein as collectively comprising an “enterprise network.” Numerous other operating scenarios involving a wide variety of different types and arrangements of processing devices and networks are possible, as will be appreciated by those skilled in the art.

Also, it is to be appreciated that the term “user” in this context and elsewhere herein is intended to be broadly construed so as to encompass, for example, human, hardware, software or firmware entities, as well as various combinations of such entities.

The network 104 is assumed to comprise a portion of a global computer network such as the Internet, although other types of networks can be part of the computer network 100, including a wide area network (WAN), a local area network (LAN), a satellite network, a telephone or cable network, a cellular network, a wireless network such as a Wi-Fi or WiMAX network, or various portions or combinations of these and other types of networks. The computer network 100 in some embodiments therefore comprises combinations of multiple different types of networks, each comprising processing devices configured to communicate using internet protocol (IP) or other related communication protocols.

Also associated with the command coverage assessment system 105 are one or more input-output devices, which illustratively comprise keyboards, displays or other types of input-output devices in any combination. Such input-output devices can be used, for example, to support one or more user interfaces to the command coverage assessment system 105, as well as to support communication between the command coverage assessment system 105 and other related systems and devices not explicitly shown. For example, a dashboard may be provided for a user to view a progression of the execution of the command coverage assessment system 105. One or more input-output devices may also be associated with any of the information systems 102-N.

Additionally, the command coverage assessment system 105 in the FIG. 1 embodiment is assumed to be implemented using at least one processing device. Each such processing device generally comprises at least one processor and an associated memory, and implements one or more functional modules for controlling certain features of the command coverage assessment system 105.

More particularly, the command coverage assessment system 105 in this embodiment can comprise a processor coupled to a memory and a network interface.

The processor illustratively comprises a microprocessor, a microcontroller, an application-specific integrated circuit (ASIC), a field-programmable gate array (FPGA) or other type of processing circuitry, as well as portions or combinations of such circuitry elements.

The memory illustratively comprises random access memory (RAM), read-only memory (ROM) or other types of memory, in any combination. The memory and other memories disclosed herein may be viewed as examples of what are more generally referred to as “processor-readable storage media” storing executable computer program code or other types of software programs.

One or more embodiments include articles of manufacture, such as computer-readable storage media. Examples of an article of manufacture include, without limitation, a storage device such as a storage disk, a storage array or an integrated circuit containing memory, as well as a wide variety of other types of computer program products. The term “article of manufacture” as used herein should be understood to exclude transitory, propagating signals. These and other references to “disks” herein are intended to refer generally to storage devices, including solid-state drives (SSDs), and should therefore not be viewed as limited in any way to spinning magnetic media.

The network interface allows the command coverage assessment system 105 to communicate over the network 104 with the log collection system 101, and information systems 102-N and illustratively comprises one or more conventional transceivers.

A command coverage assessment system 105 may be implemented at least in part in the form of software that is stored in memory and executed by a processor, and may reside in any processing device. The command coverage assessment system 105 may be a standalone plugin that may be included within a processing device.

It is to be understood that the particular set of elements shown in FIG. 1 for command coverage assessment system 105 involving the log collection system 101, and information systems 102-N of computer network 100 is presented by way of illustrative example only, and in other embodiments additional or alternative elements may be used. Thus, another embodiment includes additional or alternative systems, devices and other network entities, as well as different arrangements of modules and other components. For example, in at least one embodiment, one or more of the command coverage assessment system 105 can be on and/or part of the same processing platform.

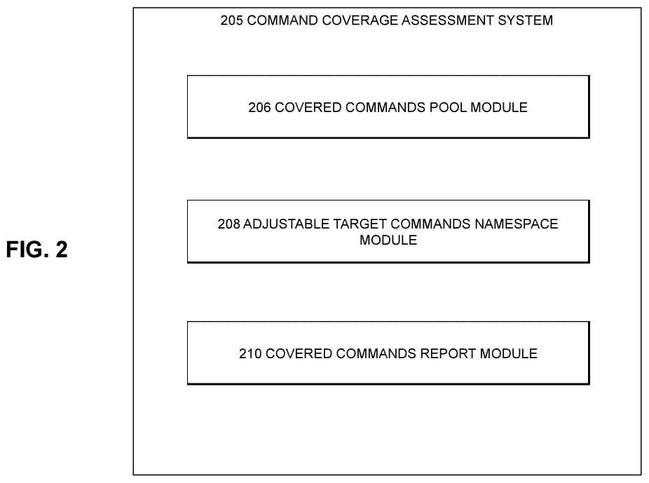

FIG. 2 shows a command coverage assessment system 205. The command coverage assessment system 205 comprises the covered commands pool module 206, the adjustable target commands namespace module 208, and the covered commands report module 210. Each of the modules are explained in further detail below.

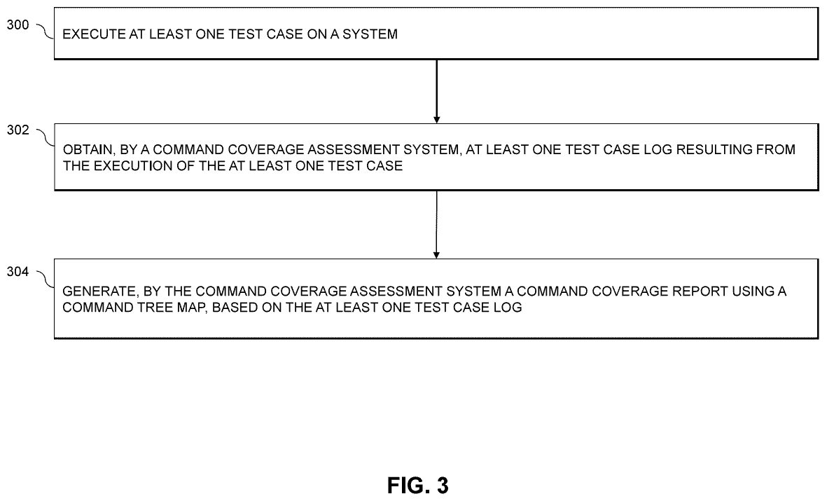

An exemplary process of command coverage assessment system 105 in computer network 100 will be described in more detail with reference to, for example, the flow diagram of FIG. 3.

FIG. 3 is a flow diagram of a process for execution of the command coverage assessment system 105 in an illustrative embodiment. It is to be understood that this particular process is only an example, and additional or alternative processes can be carried out in other embodiments.

At 300, at least one test case is executed on an information system 102-N. Typically, a coverage check is performed for product code by running code coverage testing. In response, a code coverage report is generated. The command coverage assessment system 105 provides additional functionality of performing coverage check for users commands. In an example embodiment, the command coverage assessment system 105 determines if the code coverage analysis is to be performed on existing test case logs. If not, regression testing is executed on the information system 102-N to generate the test case logs (in this case, “new” or “recently generated” test case logs). At 302, the command coverage assessment system 105 obtains at least one test case log resulting from the execution of the test case that was executed on the information system 102-N. Once, the test case logs have been generated, the command coverage assessment system 105 generates the command coverage report based on the actual test logs.

At 303, the command coverage assessment system 105 generates a command coverage report using a command tree map, based on the test case log. In an example embodiment, the covered commands pool module 206 parses the test case log to obtain commands transmitted to the system during the execution of the test case. In each regression testing cycle, a repository is created (for example, a folder) in which the test case logs are stored. The command coverage assessment system 105 comprises an interface that iteratively searches the test case logs in a designated repository.

In an example embodiment, the covered commands pool module 206 obtains a plurality of covered commands and a covered command count associated with each of the respective plurality of covered commands. The covered command count indicates a total occurrence of each of the respective plurality of covered commands in the test logs. In an example embodiment, the covered commands pool module 206 parses the test case logs to record “covered commands” (i.e., commands transmitted to the system during the execution of the test case), as well as other covered commands information, such as how many times a covered command appears in the test log, and which test logs contain which covered commands. In other words, the covered commands pool module 206 processes the regression tests' execution logs to parse commands that were sent to the information system 102-N for processing. Parsing the regression tests' execution logs collects the commands coverage information from the actual testing. As explained below, the covered commands pool module 206 then normalizes the covered command count (i.e., how many times the covered command appears in the test log) as a hit ratio to update the user commands coverage status.

In an example embodiment, the covered commands pool module 206 updates the command tree map associated with a covered command with the respective covered command count. In an example embodiment, each command tree map (also referred to as a primary child store) is updated with a testing hit ratio (as explained below) based on actual coverage statistics.

In an example embodiment, a covered commands report module 210 outputs an analysis report indicating whether target commands in a target commands namespace are covered in a covered commands pool associated with a covered commands pool module, where the covered commands pool comprises covered commands in at least one test log. The analysis report indicates whether target commands on the adjustable target commands namespace are covered in the covered commands pool. In an example embodiment, the analysis report also provides a coverage level associated with the covered commands and a coverage level requirement threshold. This information assists test engineers in determining any testing gaps in the regression testing, and then resolve those testing gaps to meet functional regression coverage requirements.

In an example embodiment, the command coverage assessment system 105 evaluates at least one test case log to identify usage of at least one command used during the execution of a test case that resulted in the production of the test case log. In an example embodiment, the command coverage assessment system 105 generates a data structure for command coverage analysis. The data structure assists in the storing, searching and comparing of the commands for coverage analysis. In an example embodiment, the command coverage assessment system 105 instantiates at least one command tree map comprising at least one primary node and at least one child node. The entrance of the command tree map is the command itself. The primary node is the middle parameter and the child node is the last parameter used in the command line. Command coverage is evaluated by comparing a target command tree map with an updated command tree map generated by parsing the test case logs.

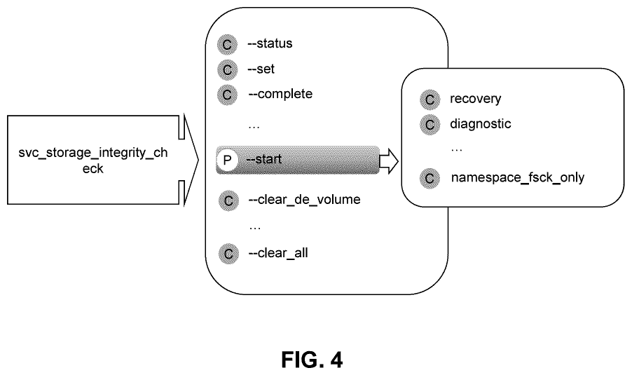

A command tree map (or primary child store) of the svc_storage_integrity_check command is illustrated below. FIG. 4 also illustrates the primary child store layout for the svc_storage_integrity_check command.

```
usage: svc_storage_integrity_check [-h] [--status] [--set VOLUME_ID] [-f]
  [--complete] [--list_faulted_cp_objects]
  [--list_cleared_file_volumes_marked_dl]
  [--show_library_compatability]
  [--clear VOLUME_ID]
  [--service_lost_and_found]
  [--list_de_volumes]
  [--start
[{recovery,diagnostic,namespace_diagnostic,mapper_diagnostic,logger_diagnostic,namespace_f
sck_only}]]
  [--clear_de_volume CLEAR_DE_VOLUME]
  [--repair_layered_services] [--dpcli]
  [--block_recovery] [--list_faulted_volumes]
  [--clear_all]
```

In an example embodiment, an adjustable target commands namespace module 208 generates a target commands namespace comprising at least one target command. The test case (that is executed to produce the test case log) tests at least one target command. Typically, when software products are created, functional specifications are also drafted that guide users how to use the software products, meaning how to use the different commands that are available when using the software product. Different teams are assigned to different product components and each product component team is responsible for the development and testing of the commands detailed in the functional specifications. The target commands namespace is generated to include those commands that are detailed in the functional specifications. Thus, the target commands namespace comprises the target commands that should be tested by a set of defined regression test cases associated with each of the product components. Further, the functional specifications are the materials that the customers reference when using the software products. The functional specifications describe use cases, and the more frequently used commands. Thus, the functional specifications may be leveraged to evaluate the effectiveness and priority of the regression testing effort. The frequently used commands that the customers execute are more important and therefore have a higher priority in testing coverage analysis. In an example embodiment, the adjustable target commands namespace module 208 assigns normalized weights (of 0 to 100) to commands in in the functional specifications. The coverage weights indicate the command coverage priority information that is collected from the functional specifications, and are the target references for the later regression test case coverage analysis. The actual commands' usage in the functional specifications typically reflect their degree of importance.

In an example embodiment, different target commands namespaces may be defined based on different testing scopes associated with the regression test cases. The use of adjustable target command namespaces makes the command coverage assessment system 105 more adaptable to analysis coverage status for different testing scopes. The initialized adjustable target command namespaces are optimum references of the actual regression test cases' coverage targets. The use of a code coverage tool in tandem with the command coverage assessment system 105 ensures functions triggered by customer-initiated commands are covered in priority, and assists in exposing functional testing issues as early as possible in the testing cycle. In an example embodiment, adjustable target command namespaces may be defined for different software systems. The statistics generated for each of the different adjustable target command namespaces are reusable to report different analysis results depending on which adjustable target command namespace were used to report the results. This means coverage status can be selected based on which adjustable target command namespace is selected.

In an example embodiment, the adjustable target commands namespace module 208 obtains the commands coverage information from functional specifications. Below illustrates use cases for a command class “command A”. The same use case processing is performed for other commands in the functional specification, such as “command B”, “command C”, . . . “command N”, etc.

Use case1:
...
command A -param1
...
command A -param3
...
command A -param3
Use case2:
...
command A -param2
...
command A -param1
...
command A -param2
Use case3:
...
command A -param2
...
command A -param3
...
command A -param2

In an example embodiment, the more frequently used command combinations are assigned a higher weight based on the following functions:
Total Commands occurrences: Ω(A)
Command x occurrences: f(x)
Normalized weight of command x: 100*f(x)/Ω(A)

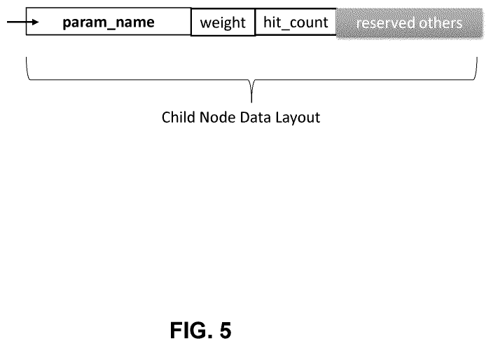

In an example embodiment, the adjustable target commands namespace module 208 obtains from a target commands namespace the target command coverage information. The adjustable target commands namespace module 208 assigns a weight to the target command coverage information, and stores the weight in a child node of the command tree map. In an example embodiment, the adjustable target commands namespace module 208 stores a sum of a plurality of weights in a primary node, where the plurality of weights is associated with a respective plurality of child nodes associated with the primary node, and where the plurality of child nodes comprises the child node. In an example embodiment, the weight is stored in each node of a command tree map. The child nodes have a field to store the weight of each combination of the command, and the primary node has a field to store the sum of the weights for all corresponding child nodes. In an example embodiment, the child node of the command tree map has two extra fields reserved for the weight of a target command and the hit ratio that occurs during the execution of the test case. FIG. 5 illustrates the child node data layout of the command tree map. As noted above, the child node comprises a hit ratio associated with a command executed during the execution of the test case. In an example embodiment, the hit ratio is a normalized covered command count, where the covered command count indicates a total occurrence of a covered command found in the test log.

In an example embodiment, the command coverage assessment system 105 creates the command tree map for each target command in the target commands namespace, and each respective command tree map comprises full usage combinations of the target command. As noted above, each command tree map comprises a primary node and one or more child nodes. In an example embodiment, the command coverage assessment system 105 creates the base command tree map (i.e., primary child store tree) for each command that is covered in the functional specifications. The base command tree map of a command is populated based on the command's output when the command is executed with “-help” to obtain the full usage combinations of the command. Any of the combination of the command's output that is not in the functional specifications is assigned a weight of zero. By leveraging the coverage information from the functionals specifications, multiple command tree maps with the command tree map layout are updated for target coverage weights. For example, if “command A” has a “-help” option, the base tree primary child store of “command A” is constructed based on the output of command A [--param1] [--param2] [--param3] [--param4].

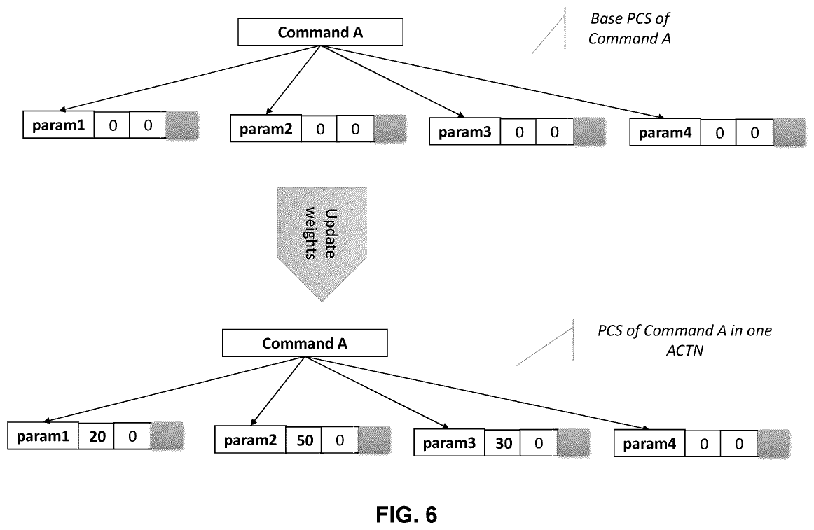

In an example embodiment, the command coverage assessment system 105 updates the weight in the child node of the command tree map based on information associated with the full usage combination of the command. FIG. 6 illustrates updating the weights of the base tree primary child store of “command A”.

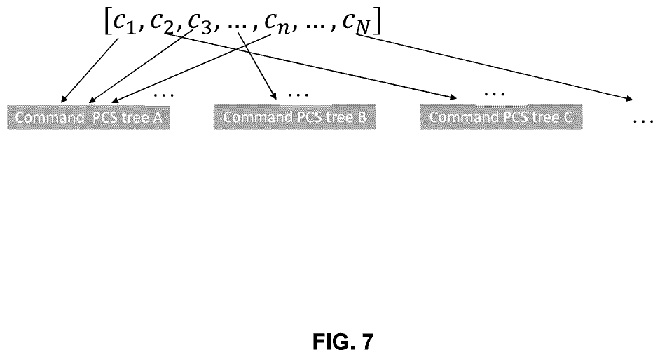

In an example embodiment, adjustable target commands namespaces are, as their name implies, adjustable, and updated based on different requirements. In an example embodiment, different components in software products may have their own adjustable target commands namespace to analyze and obtain coverage results. In an example embodiment, “C” is a list of commands stored in the adjustable target commands namespace, where C=[c₁, c₂, . . . , cₙ, . . . , c_{N}], and “N” is the number of commands in the adjustable target commands namespace that are stored in groups of command tree maps. FIG. 7 illustrates the storing of commands in groups of command tree maps. In an example embodiment, the list of commands, “C” is adjustable; commands may be added, and/or legacy commands may be removed, if necessary.

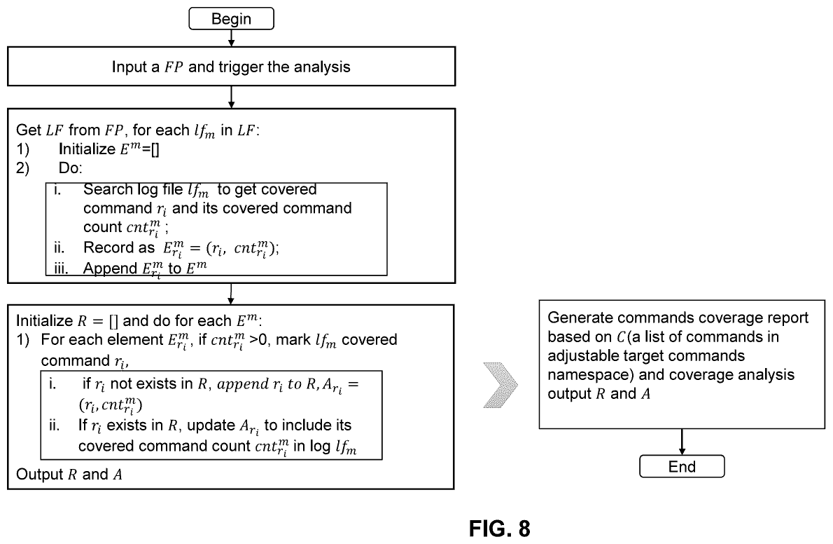

FIG. 8 illustrates a flowchart to collect coverage statistics. In an example embodiment, FP represents the folder path where the test case logs are stored, and LF represents a set of files of test case logs discoverable by searching FP, where LF=[lf₁, lf₂, . . . , lfₘ, . . . , lf_{M}], where M represents the number of test case logs found in the folder. The command coverage assessment system 105 accepts FP as an input. In an example embodiment, the command coverage assessment system 105 searches for, and records each test case log file to obtain the covered commands and covered command count for each lfₘ in LF. In an example embodiment, a set of commands found in logs R, where R=[r1, r2, . . . , ri, . . . rI]; this data is used to update the command tree maps. A list of covered commands and their respective covered command count found in the test case log file lfₘ is represented by E^{m}, where the command coverage assessment system 105 initializes E^{m}=[ ]. The variable Eᵣ_{ᵢ}^{m} represents a record of command rᵢ and its respective covered command count cntᵣ_{ᵢ}^{m} in test case log file lfₘ, where Eᵣ_{ᵢ}^{m}=(rᵢ, cntᵣ_{ᵢ}^{m}), and where Eᵣ_{ᵢ}^{m} is appended to E^{m} as one element. In an example embodiment, the command coverage assessment system 105 searches the test log file lfₘ for covered command rᵢ and it's covered command count cntᵣ_{ᵢ}^{m}, then records them as Eᵣ_{ᵢ}^{m}=(rᵢ, cntᵣ_{ᵢ}^{m}). Then, E^{m} is appended to E^{m}.

A record of generated statistics in the covered commands pool is represented by “A” and each element Aᵣ_{ᵢ} in A is a record of the covered command rᵢ, and its covered command count cntᵣ_{ᵢ}^{m}, where Aᵣ_{ᵢ}=(rᵢ, Σₘ₌₁^{M} cntᵣ_{ᵢ}^{m}). The record A may also include a list of test case logs that cover the commands in Aᵣ_{ᵢ}.

In an example embodiment, R=[ ] is initialized, and for each element Eᵣ_{ᵢ}^{m} in E^{m}, (and these steps are performed for each E^{m}) if covered command count cntᵣ_{ᵢ}^{m}>0, review test case log file lfₘ for covered command rᵢ. If rᵢ does not exist in R, append rᵢ to R, Aᵣ_{ᵢ}=(rᵢ, cntᵣ_{ᵢ}^{m}). If rᵢ exists in R, update A to include covered command count cntᵣ_{ᵢ}^{m} in test case log file lfₘ, such that

$${A}_{{r}_{i}} = ( {r}_{i} , {\sum }_{m = 1}^{M} {cnt}_{{r}_{i}}^{m} ) .$$

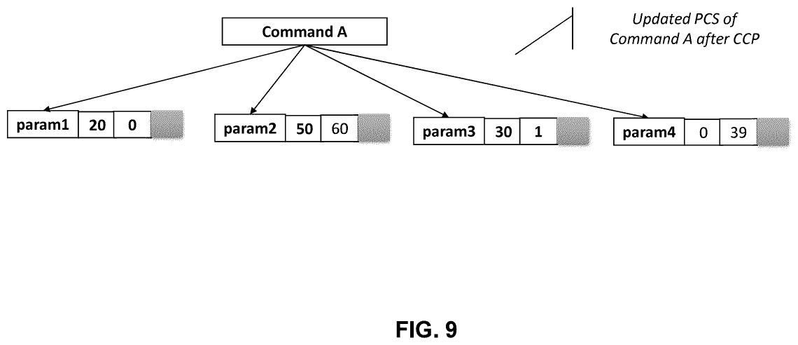

In an example embodiment, Aᵣ_{ᵢ} is used to update the command tree map (i.e., primary child store) of command rᵢ. Then, the covered command count is normalized to become the hit ratio after all the commands in “R” are updated. In an example embodiment, the covered commands report module 210 generates the covered commands report based on “C” (which is the list of commands in the adjustable target commands namespace) and the coverage analysis. FIG. 9 illustrates the updated command tree map (i.e., primary child store) of the command “A” after the covered command pool. This provides the coverage result of Command “A”.

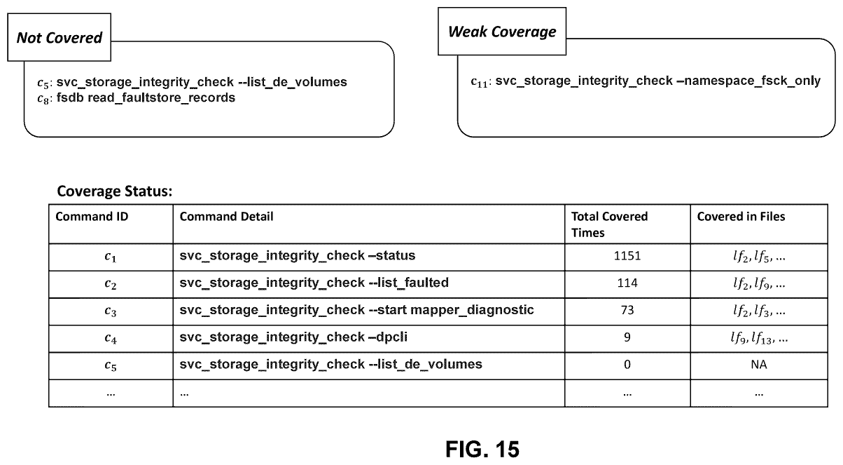

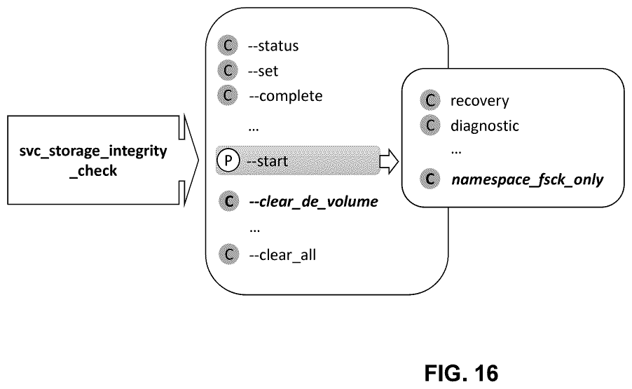

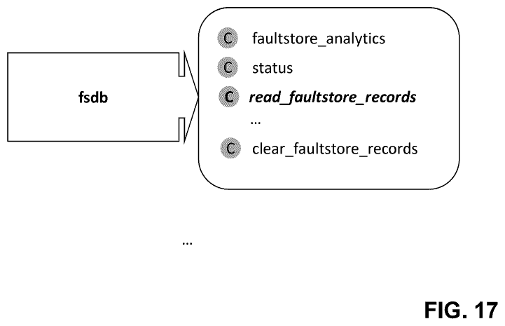

In an example embodiment, the command coverage assessment system 105 queries the command tree map associated with a command to determine whether target commands in the adjustable target commands namespace are covered in the covered commands pool, as well as whether the commands' coverage level meets a requirement threshold (which is reflected by their weights and testing hit ratios). In an example embodiment, the commands coverage report is obtained by querying a command tree map to determine whether the actual testing coverage meets the target requirements. An example of the report is illustrated in FIG. 15, FIG. 16, and FIG. 17. In an example embodiment, the functional tests would require review to determine whether the missing coverage is unexpected. The functional tests would also require review to determine whether the existing test cases require enhancement or whether new test cases need to be developed. Thus, the command coverage assessment system 105 reveals what commands are missing coverage and what commands have weak coverage, or weaker coverage than the requirement threshold.

In an example embodiment, as illustrated in FIG. 9, “-param3” associated with command “A” has a relatively high weight 30 in the functional specification, but only a testing hit ratio of 1. This indicates the coverage of command A-param3 may not have enough coverage in the actual testing that occurs in the regression test cases. In addition, the coverage of command A-param1 shows no testing hit ratio, indicating there is missing test coverage for this command.

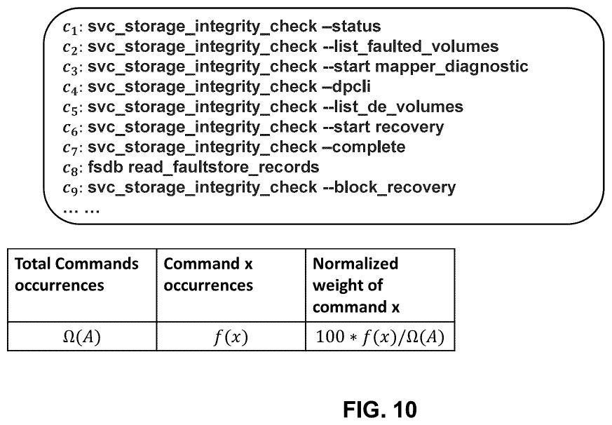

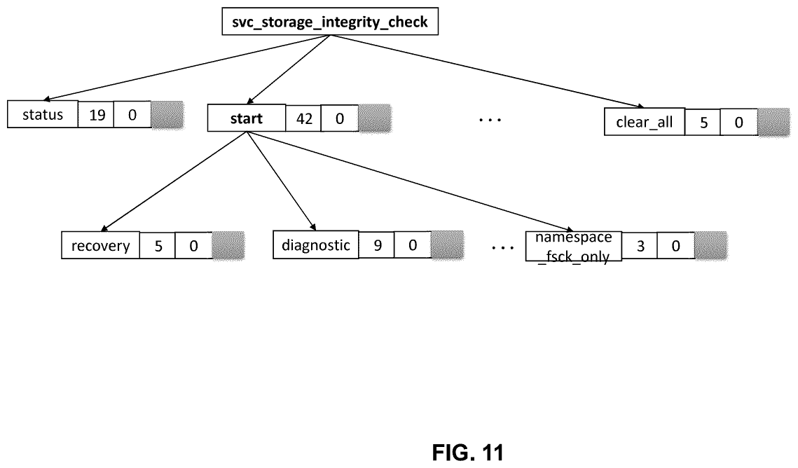

In an example embodiment, using data path recovery as an example, commands used by the customers are obtained from the specifications provided to the customers, and these commands are added to an adjustable target commands namespace. Multiple command tree maps with a primary child store layout are constructed. The regression test cases should have coverage on these commands with priority weights. FIG. 10 illustrates the information that is collected to update the command tree maps for this example. FIG. 11 illustrates a command tree map for the “svc_storage_integrity_check” command.

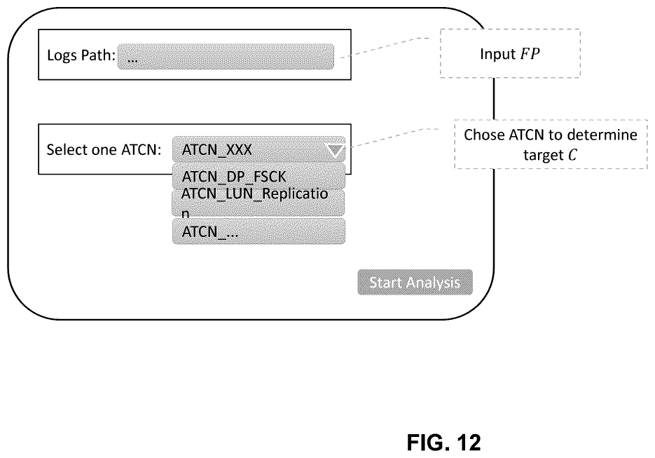

In an example embodiment, the command coverage assessment system 105 provides an interface with selectable options to trigger analysis. FIG. 12 illustrates an example interface. FIG. 10 illustrates the information that is collected to update the command tree maps for the ATCN_DP_FSCK option that is illustrated in FIG. 12.

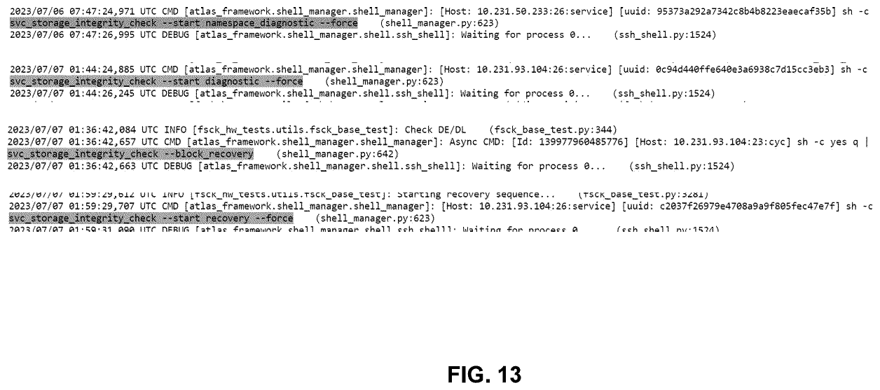

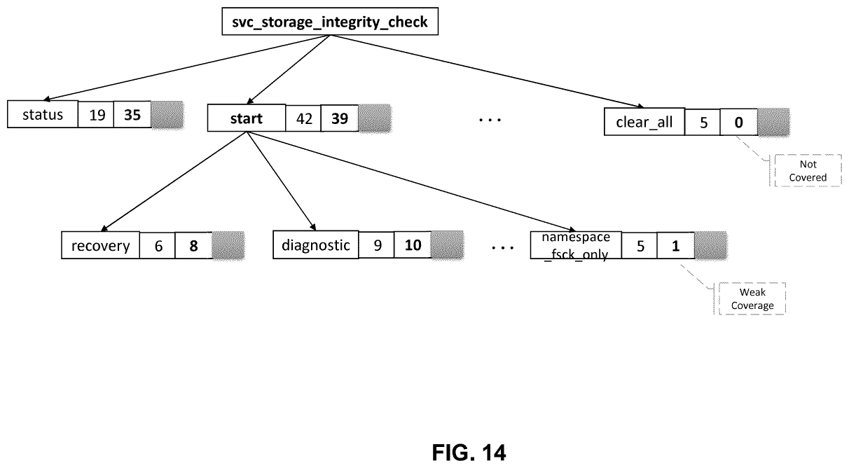

In an example embodiment, FIG. 13 illustrates the test case logs that the command coverage assessment system 105 analyzes in the test logs path FP, processing the test logs according to the algorithm illustrated in FIG. 8. In an example embodiment, the covered commands pool module 206 parses the test case execution logs and then updates each command tree map (i.e., primary child store) based on the analysis result. FIG. 14 illustrates the updated command tree map reflecting the actual coverage statistics. In an example embodiment, a visual report is efficiently generated by querying the command tree maps. In an example embodiment, if the analysis is triggered twice, the command coverage assessment system 105 verifies whether the test case logs in the folder have been modified. If the test case logs have not been modified, the command coverage assessment system 105 utilizes the latest analysis result corresponding to FP. In an example embodiment, if the analysis is triggered twice, the command coverage assessment system 105 verifies whether the regression test cases have been updated to fill any gaps between the functional specifications (indicating the actual code usage by the customers) and the regression testing.

Accordingly, the particular processing operations and other functionality described in conjunction with the flow diagram of FIG. 3 are presented by way of illustrative example only, and should not be construed as limiting the scope of the disclosure in any way. For example, the ordering of the process steps may be varied in other embodiments, or certain steps may be performed concurrently with one another rather than serially.

The above-described illustrative embodiments provide significant advantages relative to conventional approaches. For example, some embodiments are configured to provide a command coverage assessment system that utilizes both the functional specifications and the regression test logs to increase the code testing coverage. These and other embodiments can effectively improve code coverage testing on information systems relative to conventional approaches. For example, embodiments disclosed herein provide information for code coverage testing that prioritizes code paths that are touched by users. Embodiments disclosed herein provide information to develop regression tests to meet code coverage requirements using customer inputs and usage details. Embodiments disclosed herein provide coverage analysis for the commands used by customers by analyzing test logs. Embodiments disclosed herein identify and resolve the gap between the functional specifications and the actual code usage by the customers. Embodiments disclosed herein provide a tool that can utilize both the functional specifications and the regression test logs to increase the code testing coverage.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

As mentioned previously, at least portions of the information processing system 100 can be implemented using one or more processing platforms. A given such processing platform comprises at least one processing device comprising a processor coupled to a memory. The processor and memory in some embodiments comprise respective processor and memory elements of a virtual machine or container provided using one or more underlying physical machines. The term “processing device” as used herein is intended to be broadly construed so as to encompass a wide variety of different arrangements of physical processors, memories and other device components as well as virtual instances of such components. For example, a “processing device” in some embodiments can comprise or be executed across one or more virtual processors. Processing devices can therefore be physical or virtual and can be executed across one or more physical or virtual processors. It should also be noted that a given virtual device can be mapped to a portion of a physical one.

Some illustrative embodiments of a processing platform used to implement at least a portion of an information processing system comprises cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components, or portions thereof, are illustratively implemented for use by tenants of such a multi-tenant environment.

As mentioned previously, cloud infrastructure as disclosed herein can include cloud-based systems. Virtual machines provided in such systems can be used to implement at least portions of a computer system in illustrative embodiments.

In some embodiments, the cloud infrastructure additionally or alternatively comprises a plurality of containers implemented using container host devices. For example, as detailed herein, a given container of cloud infrastructure illustratively comprises a Docker container or other type of Linux Container (LXC). The containers are run on virtual machines in a multi-tenant environment, although other arrangements are possible. The containers are utilized to implement a variety of different types of functionality within the information processing system 100. For example, containers can be used to implement respective processing devices providing compute and/or storage services of a cloud-based system. Again, containers may be used in combination with other virtualization infrastructure such as virtual machines implemented using a hypervisor.

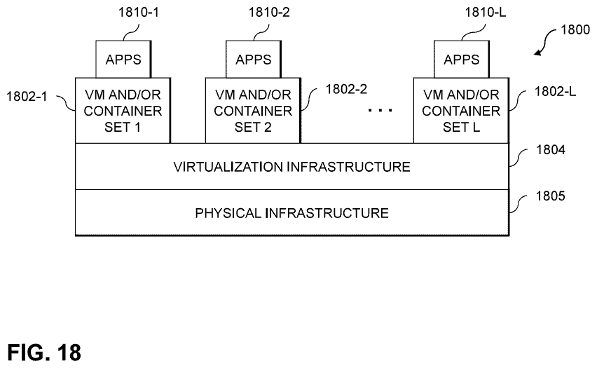

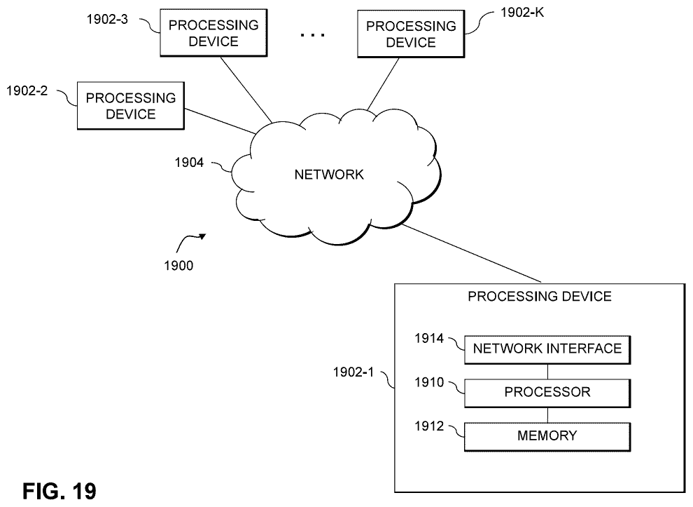

Illustrative embodiments of processing platforms will now be described in greater detail with reference to FIGS. 18 and 19. Although described in the context of the information processing system 100, these platforms may also be used to implement at least portions of other information processing systems in other embodiments.

FIG. 18 shows an example processing platform comprising cloud infrastructure 1800. The cloud infrastructure 1800 comprises a combination of physical and virtual processing resources that are utilized to implement at least a portion of the information processing system 100. The cloud infrastructure 1800 comprises multiple virtual machines (VMs) and/or container sets 1802-1, 1802-2, . . . 1802-L implemented using virtualization infrastructure 1804. The virtualization infrastructure 1804 runs on physical infrastructure 1805, and illustratively comprises one or more hypervisors and/or operating system level virtualization infrastructure. The operating system level virtualization infrastructure illustratively comprises kernel control groups of a Linux operating system or other type of operating system.

The cloud infrastructure 400 further comprises sets of applications 1810-1, 1810-2, . . . 1810-L running on respective ones of the VMs/container sets 1802-1, 1802-2, . . . 1802-L under the control of the virtualization infrastructure 1804. The VMs/container sets 1802 comprise respective VMs, respective sets of one or more containers, or respective sets of one or more containers running in VMs. In some implementations of the FIG. 18 embodiment, the VMs/container sets 1802 comprise respective VMs implemented using virtualization infrastructure 1804 that comprises at least one hypervisor.

A hypervisor platform may be used to implement a hypervisor within the virtualization infrastructure 1804, where the hypervisor platform has an associated virtual infrastructure management system. The underlying physical machines comprise one or more distributed processing platforms that include one or more storage systems.

In other implementations of the FIG. 18 embodiment, the VMs/container sets 1802 comprise respective containers implemented using virtualization infrastructure 1804 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of the information processing system 100 may each run on a computer, server, storage device or other processing platform element. A given such element is viewed as an example of what is more generally referred to herein as a “processing device.” The cloud infrastructure 1800 shown in FIG. 18 may represent at least a portion of one processing platform. Another example of such a processing platform is processing platform 1900 shown in FIG. 19.

The processing platform 1900 in this embodiment comprises a portion of the information processing system 100 and includes a plurality of processing devices, denoted 1902-1, 1902-2, 1902-3, . . . 1902-K, which communicate with one another over a network 1904.

The network 1904 comprises any type of network, including by way of example a global computer network such as the Internet, a WAN, a LAN, a satellite network, a telephone or cable network, a cellular network, a wireless network such as a Wi-Fi or WiMAX network, or various portions or combinations of these and other types of networks.

The processing device 1902-1 in the processing platform 1900 comprises a processor 1910 coupled to a memory 1912.

The processor 1910 comprises a microprocessor, a microcontroller, an application-specific integrated circuit (ASIC), a field-programmable gate array (FPGA) or other type of processing circuitry, as well as portions or combinations of such circuitry elements.

The memory 1912 comprises random access memory (RAM), read-only memory (ROM) or other types of memory, in any combination. The memory 1912 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture comprises, for example, a storage array, a storage disk or an integrated circuit containing RAM, ROM or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 1902-1 is network interface circuitry 1914, which is used to interface the processing device with the network 1904 and other system components, and may comprise conventional transceivers.

The other processing devices 1902 of the processing platform 1900 are assumed to be configured in a manner similar to that shown for processing device 1902-1 in the figure.

Again, the particular processing platform 1900 shown in the figure is presented by way of example only, and the information processing system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide Docker containers or other types of LXCs.

As another example, portions of a given processing platform in some embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage products or devices, or other components are possible in the information processing system 100. Such components can communicate with other elements of the information processing system 100 over any type of network or other communication media.

For example, particular types of storage products that can be used in implementing a given storage system of a distributed processing system in an illustrative embodiment include all-flash and hybrid flash storage arrays, scale-out all-flash storage arrays, scale-out NAS clusters, or other types of storage arrays. Combinations of multiple ones of these and other storage products can also be used in implementing a given storage system in an illustrative embodiment.

It should again be emphasized that the above-described embodiments are presented for purposes of illustration only. Many variations and other alternative embodiments may be used. Also, the particular configurations of system and device elements and associated processing operations illustratively shown in the drawings can be varied in other embodiments. Thus, for example, the particular types of processing devices, modules, systems and resources deployed in a given embodiment and their respective configurations may be varied. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A method comprising:
executing at least one test case on a system;
obtaining, by a command coverage assessment system, at least one test case log resulting from the execution of the at least one test case; and
generating, by the command coverage assessment system a command coverage report using a command tree map, based on the at least one test case log, wherein the method is implemented by at least one processing device comprising a processor coupled to a memory.

2. The method of claim 1 wherein generating, by the command coverage assessment system, the command coverage report comprises:
parsing, by a covered commands pool module, the at least one test case log, to obtain commands transmitted to the system during the execution of the at least one test case, wherein the command coverage assessment system comprises the covered commands pool module.

3. The method of claim 2 wherein parsing, by the covered commands pool module comprises:
obtaining, by the covered commands pool module, a plurality of covered commands and a covered command count associated with each of the respective plurality of covered commands, wherein the covered command count indicates a total occurrence of the each of the respective plurality of covered commands in the at least one test log.

4. The method of claim 3 further comprising:
updating the command tree map associated with a covered command with the respective covered command count, wherein the plurality of covered commands comprises the covered command.

5. The method of claim 1 wherein generating, by the command coverage assessment system, the command coverage report comprises:
outputting, by a commands coverage report module, an analysis report indicating whether target commands in a target commands namespace are covered in a covered commands pool associated with a covered commands pool module, wherein the covered commands pool comprises covered commands in the at least one test log, wherein the command coverage assessment system comprises the commands coverage report module and the covered commands pool module.

6. The method of claim 5 wherein the analysis report further comprises a coverage level associated with the covered commands and a coverage level requirement threshold.

7. The method of claim 1 wherein generating, by the command coverage assessment system, the command coverage report comprises:
evaluating, by the command coverage assessment system, the at least one test case log to identify usage of at least one command used during the execution of the at least one test case.

8. The method of claim 7 wherein evaluating, by the command coverage assessment system, the at least one test case log comprises:
generating a data structure for command coverage analysis.

9. The method of claim 8 wherein generating the data structure comprises:
instantiating at least one command tree map comprising at least one primary node and at least one child node.

10. The method of claim 1 wherein generating, by the command coverage assessment system, the command coverage report comprises:
generating, by an adjustable target commands namespace module, a target commands namespace comprising at least one target command, wherein the at least one test case comprises testing the at least one target command, and wherein the command coverage assessment system comprises the adjustable target commands namespace module.

11. The method of claim 1 wherein generating, by the command coverage assessment system, the command coverage report comprises:
obtaining from a target commands namespace, target command coverage information;
assigning a weight to the target command coverage information; and
storing the weight in a child node of the command tree map.

12. The method of claim 11 wherein the child node comprises a hit ratio associated with a command executed during the execution of the test case.

13. The method of claim 12 wherein the hit ratio is a normalized covered command count, wherein the covered command count indicates a total occurrence of a covered command in the at least one test log.

14. The method of claim 11 further comprising:
storing a sum of a plurality of weights in a primary node, wherein the plurality of weights is associated with a respective plurality of child nodes associated with the primary node, wherein the plurality of child nodes comprises the child node.

15. The method of claim 12 further comprising:
creating the command tree map for each target command in the target commands namespace, wherein each respective command tree map comprises full usage combinations of the target command, wherein each respective command tree map comprises a respective primary node and at least one respective child node.

16. The method of claim 15 further comprising:
updating the weight in the child node of the command tree map based on information associated with the full usage combination of the command.

17. The method of claim 1 wherein generating, by the command coverage assessment system, the command coverage report comprises:
querying the command tree map associated with a command to determine whether a covered commands pool associated with a covered commands pool module comprises the command, wherein a target commands namespace associated with an adjustable target commands namespace module comprises the command, wherein the command coverage assessment system comprises the adjustable target commands namespace module and the covered commands pool module.

18. The method of claim 17 further comprising:
determining whether a coverage level associated with the command meets a requirement threshold.

19. A system comprising:
at least one processing device comprising a processor coupled to a memory;
the at least one processing device being configured:
to execute at least one test case on a system;
to obtain, by a command coverage assessment system, at least one test case log resulting from the execution of the at least one test case; and
to generate, by the command coverage assessment system a command coverage report using a command tree map, based on the at least one test case log.

20. A computer program product comprising a non-transitory processor-readable storage medium having stored therein program code of one or more software programs, wherein the program code when executed by at least one processing device causes said at least one processing device:
to execute at least one test case on a system;
to obtain, by a command coverage assessment system, at least one test case log resulting from the execution of the at least one test case; and
to generate, by the command coverage assessment system a command coverage report using a command tree map, based on the at least one test case log.
